(19) United States
(12) Patent Application Publication
(10) Pub. No.: US 2022/0046211 A1
(43) Pub. Date: Feb. 10, 2022

(54) DISPLAY DEVICE AND CONTROL METHOD FOR DISPLAY DEVICE

(71) Applicant: SEIKO EPSON CORPORATION, Tokyo (JP)

(72) Inventor: Masahiko HONDA, Sapporo-shi (JP)

(21) Appl. No.: 17/395,518

(22) Filed: Aug. 6, 2021

(30) Foreign Application Priority Data
Aug. 6, 2020 (JP) 2020-133744

(51) Int. Cl. H04N 9/31; H04N 21/472

(52) U.S. Cl. CPC H04N 9/312; H04N 21/472; H04N 9/3179

(57) ABSTRACT

A display device according to an embodiment include a projecting section, a receiving section configured to receive operation by a permitted operation unit, a mode control section configured to switch a first mode and a second mode in which the operation unit, the operation by which is permitted, is different, an interface section configured to be coupled to external devices, and an identifying section configured to identify an external device to which the interface section is coupled. The mode control section executes the first mode when the interface section is not coupled to a specific external device set in advance and executes the second mode when the interface section is coupled to the specific external device.

The present application is based on, and claims priority from JP Application Serial Number 2020-133744, filed Aug. 6, 2020, the disclosure of which is hereby incorporated by reference herein in its entirety.

### BACKGROUND

### 1. Technical Field

The present disclosure relates to a display device and a control method for the display device.

### 2. Related Art

There has been known a method of limiting functions of an electronic device based on conditions (see, for example, JP-A-2016-150484 (Patent Literature 1). Patent Literature 1 discloses a technique for, in a printer having a communication function with an external device, not permitting a pairing request when a terminal device requesting pairing does not meet information stored in advance. By limiting coupling, for example, there are advantages that it is possible to prevent an outsider from operating the electronic device against an intention of an administrator and realize a state in which only a user having a specific authority operates the electronic device.

It is assumed that the limitation of the functions is changed according to a purpose of use of the electronic device. In the configuration described in Patent Literature 1, since conditions for limiting a device to be coupled are stored in advance, operation by the user having the authority is necessary when the limitation of the coupling is changed. In this way, it takes time to change the limitation of the functions.

### SUMMARY

An aspect of the present disclosure is directed to a display device including: a display section; a receiving section configured to receive operation by a permitted operation unit; a mode control section configured to switch a first mode and a second mode in which the operation unit, the operation by which is permitted, is different; a coupling section configured to be coupled to external devices; and an identifying section configured to identify the external devices to which the coupling section is coupled. The mode control section executes the first mode when the coupling section is not coupled to a specific one of the external devices set in advance and executes the second mode when the coupling section is coupled to the specific external device.

Another aspect of the present disclosure is directed to a control method for a display device including: a display section, a receiving section configured to receive operation by a permitted operation unit, and a coupling section configured to be coupled to external devices, the control method including: switching and executing a first mode and a second mode in which the operation unit, the operation by which is permitted, is different; identifying the external devices to which the coupling section is coupled; and executing the first mode when the coupling section is not coupled to a specific one of the external devices set in advance and executing the second mode when the coupling section is coupled to the specific external device.

### BRIEF DESCRIPTION OF THE DRAWINGS

FIG. 1 is a block diagram of a projector according to an embodiment.

FIG. 2 is a functional block diagram of a control system of the projector.

FIG. 3 is a schematic diagram showing a configuration example of first mode information.

FIG. 4 is a schematic diagram showing a configuration example of operation setting information.

FIG. 5 is a flowchart showing the operation of the projector.

FIG. 6 is a diagram showing a configuration example of a setting screen.

FIG. 7 is a diagram showing a configuration example of a device deletion screen.

### DESCRIPTION OF EXEMPLARY EMBODIMENTS

### 1. Overall Configuration of a Projector

An embodiment of the present disclosure is explained below with reference to the drawings.

A projector 1 includes a control section 10 that controls sections of the projector 1 and a projecting section 20. The projector 1 forms an optical image with the projecting section 20 and projects the image onto a screen SC. The projector 1 corresponds to an example of the display device. An operation of the projector 1 forming a projected image on the screen SC is equivalent to display. The projecting section 20 corresponds to an example of the display section.

The projecting section 20 includes a light source 21, a light modulation device 22, and a projection optical system 23. The projecting section 20 corresponds to an example of the display section. A light-source driving section 31 and a light-modulation-device driving section 32 that operate according to the control by the control section 10 are coupled to the projecting section 20.

The projector 1 includes an image processing section 35 that processes an image, a frame memory 36, and an image interface section 41.

The light source 21 includes a lamp such as a halogen lamp, a xenon lamp, or an ultra-high pressure mercury lamp or a solid-state light source such as an LED (Light Emitting Diode) or a laser light source. The light source 21 may include a reflector that guides light emitted by a light source to the light modulation device 22 and an auxiliary reflector. Further, the light source 21 may include a lens group and a polarizing plate for improving an optical characteristic of projected light and a dimming element that reduces, on a path leading to the light modulation device 22, a light amount of the light emitted by the light source. The light-source driving section 31 lights and extinguishes the light source of the light source 21 according to the control by the control section 10.

The light modulation device 22 includes a light modulation element and modulates the light emitted by the light source 21 and generates image light. The light modulation device 22 includes, as the light modulation element, for example, three liquid crystal panels corresponding to the three primary colors of R, G, and B. The liquid crystal panel may be a liquid crystal panel of a transmission type or may be a liquid crystal panel of a reflection type. The light emitted by the light source 21 is separated into, for example, color lights of three colors of R, G, and B and made incident on the liquid crystal panels corresponding to the color lights of R, G, and B and modulated. The color lights are combined by a combination optical system such as a cross dichroic prism and emitted to the projection optical system 23. The light modulation element included in the light modulation device 22 is not limited and may be, for example, a digital micromirror device.

The light modulation device 22 is driven by the light-modulation-device driving section 32. The light-modulation-device driving section 32 is coupled to the image processing section 35 explained below. Image data corresponding to the primary colors of R, G, and B are input to the light-modulation-device driving section 32 from the image processing section 35. The light-modulation-device driving section 32 converts the input image data into signals suitable for the operation of the liquid crystal panels. The light-modulation-device driving section 32 applies a voltage to the liquid crystal panels of the light modulation device 22 based on the converted signal and draws images on the liquid crystal panels.

The projection optical system 23 includes a lens and a mirror that form an image of the incident image light on the screen SC. The projection optical system 23 may include a zoom mechanism for enlarging or reducing an image projected onto the screen SC and a focus adjusting mechanism for performing adjustment of a focus.

Image data of an image to be displayed on the screen SC is input to the image processing section 35 according to the control by the control section 10. The image processing section 35 develops the input image data in the frame memory 36. The frame memory 36 includes a plurality of banks. The banks have a storage capacity for enabling image data for one frame to be written. The frame memory 36 is configured by, for example, an SDRAM (Synchronous Dynamic Random Access Memory).

The image processing section 35 performs, on the image data developed in the frame memory 36, image processing such as resolution conversion processing, resize processing, correction of distortion aberration, shape correction processing, digital zoom processing, or adjustment of a tint and luminance of an image.

The image processing section 35 and the frame memory 36 can be configured by, for example, an integrated circuit. The integrated circuit includes an LSI, an ASIC (Application Specific Integrated Circuit), and a PLD (Programmable Logic Device). The PLD includes, for example, an FPGA (Field-Programmable Gate Array). An analog circuit may be included in a part of the configuration of the integrated circuit. The image processing section 35 and the frame memory 36 may be a combination of a processor and the integrated circuit. The combination of the processor and the integrated circuit is called microcontroller (MCU), SoC (System-on-a-chip), system LSI, chip set, or the like.

The projector 1 includes an image interface section 41, an input processing section 42, an operation panel 43, a remote-controller-light receiving section 44.

The image interface section 41 includes a connector and an interface circuit and is coupled to an image supply device different from the projector 1. For example, the image interface section 41 includes an HDMI (High-Definition Multimedia Interface) connector and an HDMI interface circuit and is coupled to the image supply device via an HDMI cable. HDMI is a registered trademark.

Specific specifications of the image interface section 41 are not limited. For example, a USB (Universal Serial Bus) cable, a VGA cable, or the like may be capable of being coupled to the image interface section 41. For example, the number of connectors included in the image interface section 41 can be optionally changed. The image interface section 41 may include a connector to which a cable for transmitting an analog image signal is capable of being coupled and an interface circuit to which the analog image signal can be input. In this case, the image interface section 41 may include a conversion circuit that converts the analog image signal into digital image data.

The image supply device capable of being coupled to the image interface section 41 only has to be a device that outputs image data. Examples of the image supply device include a recording medium playing device such as a DVD player, a media streaming device that acquires data via a communication line and outputs image data based on the acquired data, and a communication terminal device such as a smartphone.

The operation panel 43 includes not-shown operators such as buttons and switches provided on a housing of the projector 1. The operation panel 43 receives operation on the operators, generates an operation signal corresponding to the operation, and outputs the operation signal to the input processing section 42. The input processing section 42 outputs the operation signal input from the operation panel 43 to the control section 10.

A remote controller 45 includes operators and transmits an infrared signal according to operation of the operators.

The remote-controller-light receiving section 44 receives an infrared signal transmitted from the remote controller 45 and decodes the received infrared signal to generate an operation signal. The remote-controller-light receiving section 44 outputs the generated operation signal to the input processing section 42. The input processing section 42 outputs the operation signal input from the remote-controller-light receiving section 44 to the control section 10.

The operation panel 43 and the remote controller 45 correspond to an example of the operation section.

The control section 10 includes a memory 12 and a processor 11.

The memory 12 is a storage device that stores a program to be executed by the processor 11 and data. The memory 12 is configured by a magnetic storage device, a semiconductor storage element such as a flash ROM (Read Only Memory), or a storage device of another type. The memory 12 may include a RAM (Random Access Memory) configuring a work area of the processor 11. The memory 12 stores data to be processed by the control section 10 and a control program to be executed by the processor 11.

The processor 11 may be configured by a single processor. A plurality of processors may be configured to function as the processor 11. The processor 11 executes the control program to control the sections of the projector 1. For example, the processor 11 selects, out of image supply devices coupled to the image interface section 41, an image supply device that outputs an image to be displayed. The processor 11 controls the image interface section 41 to output image data input from the image supply device to the image processing section 35. The processor 11 outputs an execution instruction for image processing and parameters used for the image processing to the image processing section 35. The parameters include, for example, a geometrical correction parameter for correcting geometrical distortion of an image projected onto the screen SC. The processor 11 controls the light-source driving section 31 to control lighting and extinction of the light source 21 and adjusts the luminance of the light source 21.

A storing section 15 is a nonvolatile storage device such as a hard disk drive or an SSD (Solid State Drive). The storing section 15 stores a program to be executed by a processor 11 explained below and data to be processed by the processor 11.

The projector 1 includes an interface section 50 as an interface for coupling an external device of the projector 1. Types and the number of devices coupled to the interface section 50 are not limited. In this embodiment, a first device 101, a second device 102, and a third device 103 are illustrated as examples. The devices coupled to the interface section 50 are collectively referred to as external device 100. That is, when the first device 101, the second device 102, and the third device 103 are collectively referred to and are not distinguished, the first device 101, the second device 102, and the third device 103 are described as external device 100. The external device 100 and the first device 101, the second device 102, and the third device 103 included in the external device 100 correspond to an example of the external device.

The interface section 50 includes one or a plurality of interfaces communicably coupled to the external device 100. In this embodiment, the interface section 50 includes a first interface 51, a second interface 52, and a third interface 53. A configuration in which the first device 101 is coupled to the first interface 51, the second device 102 is coupled to the second interface 52, and the third device 103 is coupled to the third interface 53 is explained as an example. The interface section 50 corresponds to an example of the coupling section. The first interface 51, the second interface 52, and the third interface 53 respectively correspond to an example of the interface.

The first interface 51 is a wireless communication interface that is coupled to the first device 101 by a communication link 55 and executes wireless data communication. The first interface 51 includes a wireless communication device including an antenna, an RF circuit, a baseband circuit, and an encoder/decoder. The second interface 52 is a wireless communication interface that is coupled to the second device 102 by a communication link 56 and executes wireless data communication. The second interface 52 includes a wireless communication device including an antenna, an RF circuit, a baseband circuit, and an encoder/decoder.

The first interface 51 may be configured to, for example, execute wireless communication conforming to the Bluetooth standard. In this case, the first interface 51 executes Bluetooth pairing to thereby form the communication link 55 between the first interface 51 and the first device 101 and executes wireless data communication. The first interface 51 may be configured to execute wireless communication conforming to the Wi-Fi standard. In this case, the first interface 51 operates in an infrastructure mode and executes the wireless data communication with the first device 101 through a Wi-Fi access point different from the projector 1 and the first device 101. In this case, the communication link 55 is equivalent to a wireless communication network including an access point. The first interface 51 may conform to Soft AP or the Wi-Fi direct standard and execute P2P (Peer to Peer) communication with the first device 101. Like the first interface 51, the second interface 52 may be configured to execute wireless communication conforming to the Bluetooth standard or wireless communication conforming to the Wi-Fi standard. The first interface 51 and the second interface 52 may be configured to execute short-range wireless communication using NFC (Near Field Communication) or may conform to other communication standards.

Bluetooth is a registered trademark. Wi-Fi is a registered trademark.

The first device 101 only has to be a device wirelessly communicable with the first interface 51 by the communication link 55. The second device 102 only has to be a device wirelessly communicable with the second interface 52 by the communication link 56. Examples of the first device 101 and the second device 102 include a smartphone, a tablet computer, and a laptop computer. The first device 101 and the second device 102 may be the recording medium playing device or the media streaming device described above or may be a device for operation including various buttons.

The third interface 53 includes a connector to which a cable 57 is coupled and an interface circuit that executes data communication through the cable 57. The cable 57 is a data communication cable such as an HDMI cable, a USB cable, or an Ethernet cable. The third interface 53 executes data communication conforming to various communication standards with the third device 103. Ethernet is a registered trademark.

The third device 103 only has to be a device including a connector to which the cable 57 is capable of being coupled and an interface circuit. Examples of the third device 103 include a smartphone, a tablet computer, a laptop computer and the recording medium playing device and the media streaming device described above. However, the third device 103 may be other devices.

### 2. Configuration of the Control Section

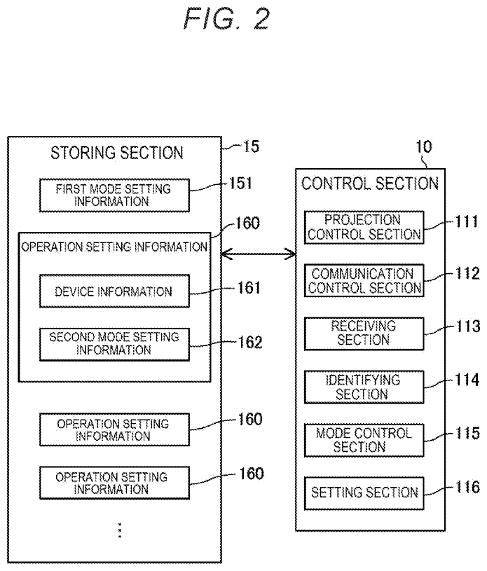

FIG. 2 is a functional block diagram showing the configuration of a control system of the projector 1 and shows an example of the configuration of the control section 10.

As shown in FIG. 2, the control section 10 of the projector 1 includes a projection control section 111, a communication control section 112, a receiving section 113, an identifying section 114, a mode control section 115, and a setting section 116. The processor 11 executes the control program stored in the memory 12, whereby these functional sections are realized by cooperation of software and hardware.

The storing section 15 stores first mode information 151 and operation setting information 160. As shown in FIG. 2, the storing section 15 is configured to be capable of storing a plurality of kinds of operation setting information 160.

The projection control section 111 controls the image processing section 35 to execute image processing based on image data. The projection control section 111 controls the light-source driving section 31 and the light-modulation-device driving section 32 to display, with the projecting section 20, on the screen SC, an image based on the image data processed by the image processing section 35.

The communication control section 112 controls the interface section 50 to execute data communication between the interface section 50 and the external device 100.

In this embodiment, the projector 1 executes communication with any one or more of the first device 101, the second device 102, and the third device 103 and receives control data and/or image data. The control data includes data for instructing the projector 1 to execute various functions. The first device 101 functions as, for example, an operation device that operates the projector 1. In this case, the first device 101 transmits the control data to the projector 1 to thereby execute various kinds of operation such as menu operation of the projector 1, setting operation for functions of the projector 1, and operation for instructing start and stop of display. In other words, the first device 101 executes the same function as the function of the remote controller 45 for operating the projector 1. The same applies to the second device 102 and the third device 103. The control data corresponds to an example of the control information.

When the first device 101, the second device 102, and/or the third device 103 transmits image data to the projector 1, the projector 1 displays, with the projecting section 20, an image based on the transmitted image data. In this case, the first device 101, the second device 102, and/or the third device 103 functions as the image supply device.

When control data is received by the interface section 50, the communication control section 112 receives, with the receiving section 113, operation corresponding to the received control data. When image data is received by the interface section 50, the communication control section 112 executes, with the projection control section 111, projection based on the received image data.

The communication control section 112 limits, according to limitation by the mode control section 115, coupling by the first interface 51, the second interface 52, and/or the third interface 53.

The receiving section 113 receives operation on the projector 1. The receiving section 113 receives operation by the operation panel 43 and/or the remote controller 45 based on an operation signal input from the input processing section 42. The receiving section 113 detects, as data indicating the operation, control data received by the interface section 50 and receives the operation.

The identifying section 114 identifies the external device 100 with which the interface section 50 executes communication. Specifically, when the first interface 51 is coupled to the first device 101, with which the first interface 51 communicates, according to the control by the communication control section 112, the identifying section 114 identifies the coupled first device 101. In this case, the identifying section 114 acquires device identification information for identifying the first device 101 and a device name, which is a name for communication processing of the first device 101. Similarly, when the second interface 52 is coupled to the second device 102, which is a device with which the second interface 52 communicates, the identifying section 114 acquires device identification information and a device name of the coupled second device 102. When the third interface 53 is coupled to the third device 103, the identifying section 114 acquires device identification information and a device name of the coupled third device 103.

The mode control section 115 controls an operation mode of the projector 1. In this embodiment, the projector 1 is capable of switching and executing a first mode and a second mode.

The first mode is executed in a state in which all of the first device 101, the second device 102, and the third device 103 are not coupled to the interface section 50. When any one of the first device 101, the second device 102, and the third device 103 is coupled to the interface section 50, the mode control section 115 switches the operation mode to the second mode. When the interface section 50 and the first device 101, the second device 102, and the third device 103 are decoupled during the execution of the second mode, the mode control section 115 switches the operation mode to the first mode.

Functions of the projector 1 in the first mode are specified by the first mode information 151. Functions of the projector 1 in the second mode are specified by the operation setting information 160. The mode control section 115 performs limitation concerning the functions of the projector 1 according to the first mode information 151 and the operation setting information 160.

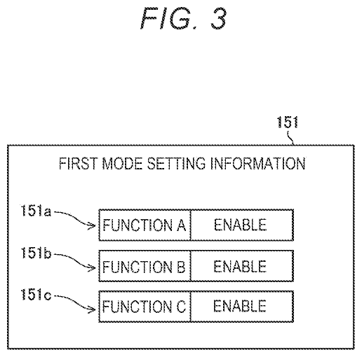

FIG. 3 is a diagram showing a configuration example of the first mode information 151.

The first mode information 151 includes information for designating a limitation state about the functions of the projector 1. In the example shown in FIG. 3, the first mode information 151 includes function setting information 151a for designating a limitation state of a function A of the projector 1, function setting information 151b for designating a limitation state of a function B, and function setting information 151c for designating a limitation state of a function C. In FIG. 3, an example is shown in which the limitation states of the functions A, B, and C are designated from enabled and disabled two states. In this example, all of the functions A, B, and C are enabled in the first mode.

The number of kinds of function setting information included in the first mode information 151 is not limited. The function setting information about a larger number of functions may be included in the first mode information 151.

The function, the limitation state of which is designated by the first mode information 151, is not limited. That is, the functions A, B, and C may be any function of the projector 1. The functions A, B, and C may be, for example, display by the projecting section 20, image processing executed by the image processing section 35, reception of operation by the operation panel 43, reception of operation by the remote controller 45, and reception of an input of image data or an image signal to the image interface section 41.

The function, the limitation state of which is designated by the first mode information 151, may be coupling of the external device 100 to the interface section 50. Specifically, propriety of coupling by the first interface 51, propriety of coupling by the second interface 52, and propriety of coupling by the third interface 53 can be selected as the functions A, B, and C.

Further, a limitation state of a more detailed communication function of the interface section 50 may be capable of being set by the first mode information 151.

For example, when the first interface 51 is configured by a Bluetooth communication module, a limitation state of a function of executing Bluetooth pairing may be designated by the first mode information 151. Bluetooth profiles of the external device 100 coupled to the first interface 51 may be individually limited. In this case, it is possible to perform setting for, for example, enabling coupling of a GAVDP (Generic Audio/Video Distribution Profile) and a VDP (Video Distribution Profile) and disabling coupling of an HID (Human Interface Device Profile) among the Bluetooth profiles.

For example, a limitation state may be capable of being set by the first mode information 151 for each of protocols used for communication. In this case, it is possible to perform setting for, for example, enabling sessions of a TCP (Transmission Control Protocol) and a UDP (User Datagram Protocol) by the third interface 53 and disabling a session of an FTP (File Transfer Protocol) by the third interface 53.

The first mode information 151 may be information for designating that the functions of the projector 1 are not limited at all. In this case, the first mode information 151 may include function setting information 151a, 151b, and 151c. The function setting information 151a, 151b, and 151c may designate that target functions are enabled. Content of the first mode information 151 may be a specific sign indicating that the functions are not limited.

The mode control section 115 refers to the first mode information 151 when executing the first mode as the operation mode of the projector 1. The mode control section 115 executes the function limitation for the projector 1 according to the setting of the function setting information 151a, 151b, and 151c. When the first mode information 151 includes a specific sign indicating that the functions are not limited, the mode control section 115 does not limit the functions of the projector 1.

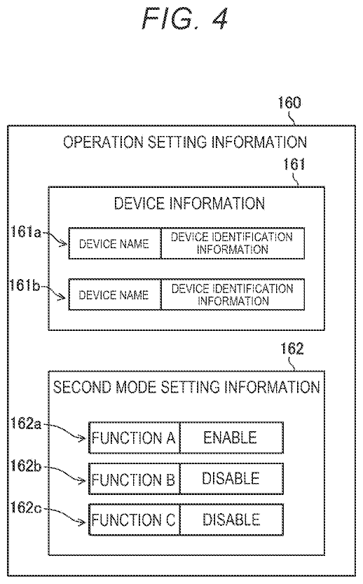

FIG. 4 is a diagram showing a configuration example of the operation setting information 160.

The operation setting information 160 includes, as shown in FIGS. 2 and 4, device information 161 and second mode setting information 162.

The device information 161 is information for specifying a condition under which the projector 1 executes the second mode. When the interface section 50 is coupled to a specific external device 100, the projector 1 in this embodiment executes the second mode. The device information 161 includes information for specifying the external device 100, which is a condition for executing the second mode. In the example shown in FIG. 4, the device information 161 includes individual device information 161a and individual device information 161b. The individual device information 161a and 161b are information for specifying the external device 100 coupled to the interface section 50 and include a device name and device identification information of one external device 100. As an example, the individual device information 161a is information for specifying the first device 101 and the individual device information 161b is information for specifying the second device 102. The device name and the device identification information are information notified from the external device 100 in processing for coupling the interface section 50 to the external device 100. The device name is a name of the external device 100 in communication performed by the interface section 50. The device identification information is information capable of specifying the external device 100 in communication processing. Examples of the device identification information include an MAC address and a Bluetooth device ID.

In the example shown in FIG. 4, the device information 161 includes individual device information 161a indicating the first device 101 and individual device information 161b indicating the second device 102. Accordingly, when the first device 101 or the second device 102 is coupled to the interface section 50, the projector 1 executes the second mode and executes limitation specified by the second mode setting information 162. The device information 161 may include individual device information corresponding to one external device 100 or may include information corresponding to three or more external devices 100.

When the storing section 15 stores a plurality of kinds of operation setting information 160, the plurality of kinds of operation setting information 160 preferably do not include individual device information corresponding to a common external device 100. That is, in the operation setting information 160 stored by the projector 1, the operation setting information 160 corresponding to one external device 100 is preferably limited to one.

When the projector 1 executes the second mode, the second mode setting information 162 designates a limited function among the functions of the projector 1 and a limitation state. Specifically, the second mode setting information 162 includes information for designating the limited function among the functions of the projector 1 and the limitation state. In the example shown in FIG. 4, the second mode setting information 162 includes function setting information 162a for designating a limitation state of the function A of the projector 1, function setting information 162b for designating a limitation state of the function B of the projector 1, and function setting information 162c for designating a limitation state of the function C of the projector 1. In FIG. 4, the limitation states of the functions A, B and C are designated from the enabled and disabled two state.

The functions A, B, and C of the projector 1, which are targets of the function setting information 162a, 162b, and 162c, are the same as the first mode information 151.

The number of kinds of function setting information included in the second mode setting information 162 is not limited. Function setting information about a larger number of functions may be included in the second mode setting information 162.

The second mode setting information 162 may be information for designating that the functions of the projector 1 are not limited at all. In this case, the second mode setting information 162 may include the function setting information 162a, 162b, and 162c. The function setting information 162a, 162b, and 162c may be in a state of designating that the target functions are enabled. Content of the second mode setting information 162 may be a specific code indicating that the functions are not limited.

The mode control section 115 refers to the second mode setting information 162 when executing the second mode as the operation mode of the projector 1. The operation setting information 160 includes the device information 161 and the second mode setting information 162 in association with each other. The mode control section 115 specifies the device information 161 corresponding to the external device 100 coupled to the interface section 50 and refers to the second mode setting information 162 associated with the device information 161. The mode control section 115 executes function limitation for the projector 1 according to the setting of the function setting information 162a, 162b, and 162c. When the second mode setting information 162 includes a specific code indicating that the functions are not limited, the mode control section 115 is set in a state in which the functions of the projector 1 are not limited.

As shown in FIG. 2, the storing section 15 may store a plurality of kinds of operation setting information 160. Accordingly, in the second mode, different function limitation can be carried out according to each of the first device 101, the second device 102, and the third device 103.

The setting section 116 performs setting concerning the first mode information 151 and the operation setting information 160. For example, the setting section 116 executes generation, deletion, and editing of the function setting information 151a, 151b and 151c according to, for example, operation received by the input processing section 42. The setting section 116 executes generation and deletion of the individual device information 161a and 161b and generation, editing, and deletion of the function setting information 162a, 162b, and 162c according to, for example, operation received by the input processing section 42.

In this embodiment, the setting section 116 limits processing for performing setting concerning the second mode setting information 162 to a state in which a target external device 100 is coupled to the interface section 50. That is, the setting section 116 enables generation and deletion of the function setting information 151a, 151b, and 151c about the external device 100 coupled to any one of the first interface 51, the second interface 52, and the third interface 53. Similarly, the setting section 116 enables generation, editing, and deletion of the function setting information 162a, 162b, and 162c only while the external device 100 corresponding to the device information 161 is coupled. Consequently, it is possible to prevent alteration of the operation setting information 160 unintended by the user.

### 3. Operation of the Projector

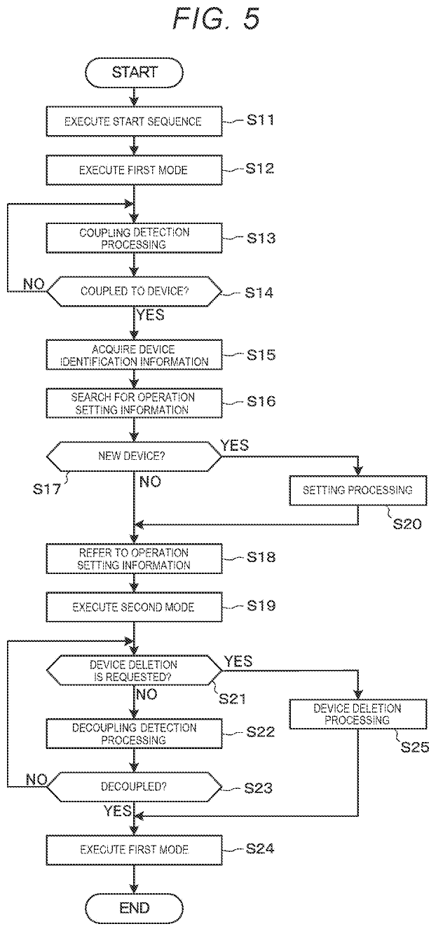

FIG. 5 is a flowchart showing the operation of the projector 1.

When a power supply of the projector 1 is turned on, the control section 10 of the projector 1 starts processing shown in FIG. 5. The control section 10 executes a start sequence of the projector 1 (step S11). In the start sequence, the control section 10 executes initialization of the sections including the projecting section 20, initialization of not-shown sensors, error check, and the like.

The mode control section 115 executes the first mode according to the first mode information 151 stored by the storing section 15 (step S12).

The communication control section 112 executes coupling detection processing (step 313). That is, the communication control section 112 detects whether the external device 100 is coupled to any one of the first interface 51, the second interface 52, and the third interface 53 included in the interface section 50.

The coupling detection processing in step S13 can be changed as appropriate according to a type of a communication standard. For example, when the first interface 51 executes P2P communication with the first device 101 or the second device 102, the communication control section 112 can detect coupling in a process of establishing communication. The P2P communication is, for example, communication using Bluetooth or SoftAP. When the second interface 52 is coupled to the second device 102 in an infrastructure mode of Wi-Fi, in specifications for transmitting a coupling request massage from the second device 102 to the projector 1, the communication control section 112 can detect the coupling. In this case, the second device 102 only has to be set to transmit a coupling request message at a communication start time. The communication control section 112 is capable of detecting in step S13 that the cable 57 is coupled to the third interface 53 or the third device 103 is coupled via the cable 57. In this way, when the interface section 50 adopts another coupling scheme and coupling detection is possible according to specifications of the coupling scheme, the communication control section 112 only has to detect coupling according to the specifications. When a step capable of detecting coupling is not included in the specifications of the coupling scheme, transmission and reception of a new message may be used.

The coupling detected by the communication control section 112 indicates that, for example, negotiation or the like is completed between the interface section 50 and the external device 100 and communication through the communication links 55 and 56 or the cable 57 is established. The present disclosure is not limited to this. For example, authentication by an application program executed by the control section 10 and the external device 100 being completed after communication is established can also be called coupling.

The mode control section 115 determines whether the first device 101, the second device 102, or the third device 103 is coupled to the interface section 50 by the communication control section 112 in step S13 (step S14). When coupling is not detected (NO in step S14), the control section 10 returns to the processing in step S13.

When the coupling to the interface section 50 is detected (YES in step S14), the identifying section 114 acquires device identification information of the external device 100, the coupling of which is detected (step S15). In step S15, the identifying section 114 may acquire a device name. The mode control section 115 searches for the operation setting information 160 based on the device identification information acquired in step S15 (step 316).

The mode control section 115 determines, based on whether the operation setting information 160 including the device identification information acquired in step S15 is found, whether the external device 100, the coupling of which is detected in step 313, is a new device (step S17).

In step S17, when the device information 161 including the device identification information acquired in step S15 is found in the storing section 15, the mode control section 115 makes a negative determination (NO in step S17). In this case, the mode control section 115 refers to the second mode setting information 162 corresponding to the device information 161 found in the storing section 15 (step 318). The mode control section 115 executes the second mode as the operation mode of the projector 1 according to the second mode setting information 162 referred to (step S19).

On the other hand, in step S17, when the device information 161 including the device identification information acquired in step 315 is not stored in the storing section 15, the mode control section 115 makes an affirmative determination (YES in step S17). In this case, the setting section 116 executes setting processing (step S20).

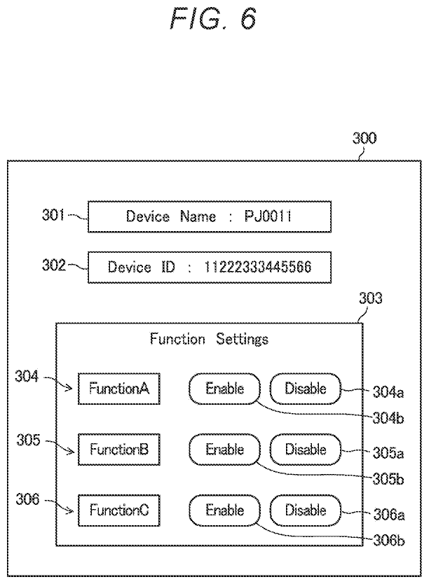

FIG. 6 is a diagram showing a configuration example of a setting screen 300 displayed by the projector 1 in the setting processing.

The setting screen 300 is a screen for generating the second mode setting information 162 in association with the external device 100 coupled to the interface section 50. The image processing section 35 generates the setting screen 300 according to control by the setting section 116. The user can set function limitation for the projector 1 in the second mode by performing operation based on the setting screen 300 using the operation panel 43, the remote controller 45, or another device for operation.

The setting screen 300 includes a device-name display section 301 and a device-identification-information display section 302. The device-name display section 301 and the device-identification-information display section 302 include the device name and the device identification information acquired from the external device 100 by the interface section 50. The user may be capable of manually setting these kinds of information. However, these kinds of information are preferably automatically acquired by the communication control section 112 and set by the setting section 116.

The setting screen 300 includes a function setting section 303. In the function setting section 303, function selecting sections 304, 305, and 306 indicating the functions A, B, and C, for which limitation is set, are arranged. In the function setting section 303, a limitation button 304a and an enabling button 304b are arranged in association with the function selecting section 304. The user selects the limitation button 304a and the enabling button 304b to set whether to enable or disable the function indicated by the function selecting section 304. Similarly, limitation buttons 305a and 306a and enabling buttons 305b and 306b are arranged in association with each of the function selecting sections 305 and 306.

The setting section 116 generates the operation setting information 160 reflecting the selection in the function setting section 303 and causes the storing section 15 to store the operation setting information 160. The mode control section 115 refers to the operation setting information 160, which is generated in the setting section 116, in step S18 and executes the second mode in step S19.

When the affirmative determination is made in step S17, the setting processing in step S20 may not be executed. In this case, the operation setting information 160 may not be generated about the external device 100 determined as being coupled in step S14. The mode control section 115 only has to maintain or execute a default operation mode, for example, maintain the first mode.

Further, in the projector 1, the setting section 116 may be capable of executing the setting processing at any timing according to operation of the operation panel 43 or the remote controller 45 or control data transmitted by the external device 100. A condition about execution timing of the setting processing is that the external device 100, which is a target of the setting processing, is coupled to the projector 1. Other limitation on timing may be absent.

In the second mode, the mode control section 115 determines presence or absence of a device deletion request by the user (step S21). In step 21, when the user is not performing operation for requesting deletion of a device, the mode control section 115 makes a negative determination (NO in step S21). In this case, the communication control section 112 executes decoupling detection processing for detecting decoupling of the external device 100 coupled to the interface section 50 (step S22).

The decoupling detection processing in step S22 can be changed as appropriate according to a type of a communication standard. For example, when the first interface 51 executes P2P communication with the first device 101 or the second device 102, the communication control section 112 can detect decoupling. The P2P communication is, for example, communication using Bluetooth or SoftAP. When the second interface 52 is coupled to the second device 102 in an infrastructure mode of Wi-Fi, a method of detecting decoupling using a message can be used. Specifically, a message for confirming that the second interface 52 is coupled to the second device 102 only has to be transmitted at a fixed period from the second interface 52. When a response to the message stops, decoupling only has to be detected. In this case, the second device 102 only has to be set to respond to the message from the second interface 52. The communication control section 112 may detect in step S22 that the cable 57 comes off from the third interface 53 or the third device 103 is detached from the cable 57. In this way, when the interface section 50 adopts another coupling scheme and decoupling detection is possible according to specifications of the coupling scheme, the communication control section 112 only has to detect decoupling according to the specifications. When a step capable of detecting decoupling is not included in the specifications of the coupling scheme, transmission and reception of a new message may be used.

The mode control section 115 determines whether the communication control section 112 detects the decoupling of the external device 100 (step S23). When the communication control section 112 does not detect the decoupling of the external device 100 (NO in step S23), the mode control section 115 returns to step S21.

When the communication control section 112 detects the decoupling of the external device 100 (YES in step S23), the mode control section 115 switches the operation mode of the projector 1 to the first mode (step S24). After the operation in step S24, the control section 10 returns to step S13.

In step S21, when the user performs operation for requesting deletion of a device using the operation panel 43, the remote controller 45, or another device for operation, the mode control section 115 makes an affirmative determination (YES in step S21). In this case, the setting section 116 executes device deletion processing (step 325).

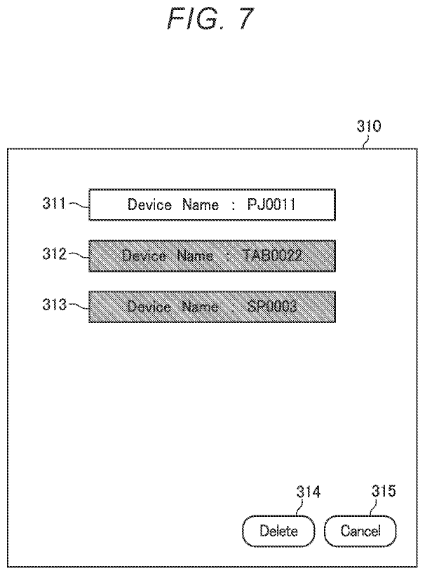

FIG. 7 is a diagram showing a configuration example of a device deletion screen 310 displayed by the projector 1 in the device deletion processing.

The device deletion screen 310 is a screen for instructing deletion of the operation setting information 160 in association with the external device 100 coupled to the interface section 50. The image processing section 35 generates the device deletion screen 310 according to control by the setting section 116. The user can cause the setting section 116 to delete the operation setting information 160 concerning the external device 100 by performing operation based on the device deletion screen 310 using the operation panel 43, the remote controller 45, or another device for operation.

The device deletion screen 310 displays, as a list, the external devices 100 for which the operation setting information 160 is set. In an example shown in FIG. 7, device display sections 311, 312, and 313 are arranged on the device deletion screen 310. The device display section 311 displays a device name of the first device 101. The device display section 312 displays a device name of the second device 102. The device display section 313 displays a display name of the third device 103.

The user selects a device name of a device requested to be deleted among the device names displayed in the device display sections 311, 312, and 313. A deletion button 314 and a cancel button 315 are arranged on the device deletion screen 310. The deletion button 314 is a button for deciding the deletion of the operation setting information 160. When the user selects any one of the device display sections 311, 312, and 313 and, then, operates the deletion button 314, the setting section 116 deletes, from the storing section 15, the operation setting information 160 corresponding to the selected device display section. In this case, the mode control section 115 shifts to step S24 and executes the first mode. When the cancel button 315 is operated, the setting section 116 stops the display of the device deletion screen 310 and suspends the device deletion processing. In this case, the mode control section 115 returns to step S21.

FIG. 7 shows, as an example, a state in which only the first device 101 is coupled and the second device 102 and the third device 103 are not coupled in the interface section 50. In this state, the setting section 116 receives deletion of the operation setting information 160 corresponding to the first device 101 but does not receive deletion of the operation setting information 160 corresponding to the second device 102 and the third device 103. Accordingly, the device display sections 312 and 313 are grayed out to indicate that the device display sections 312 and 313 cannot be selected.

In this way, the setting section 116 receives, only in the state in which the external device 100 corresponding to the operation setting information 160 is coupled, operation for instructing deletion of the operation setting information 160. Therefore, the operation setting information 160 is not deleted against an intention of the user.

Exceptionally, when the external device 100 is not coupled, the operation setting information 160 may be capable of being deleted by operation by a user having a special authority. For example, by inputting a preset password with the operation panel 43, the remote controller 45, or the external device 100, the operation setting information 160 of the external device 100 not coupled to the projector 1 at that point in time may be capable of being deleted.

A first application example and a second application example are explained as specific examples of the function limitation by the first mode and the second mode. A method of using the projector 1 is not limited to the first application example and the second application example explained below.

### 4. First Application Example

In the first application example, reception of operation by the operation panel 43 and the remote controller 45 are disabled in the second mode. In the second mode, coupling of the external devices 100 other than the specific external device 100 coupled to the interface section 50 is disabled. For example, when the first device 101 is coupled to the first interface 51, the external devices 100 other than the first device 101 cannot be coupled to the interface section 50. When the first device 101 is coupled to the first interface 51, the external devices 100 already coupled to the second interface 52 and the third interface 53 may be set to be decoupled. In the second mode, reception of control data from the devices other than the first device 101 is disabled. As explained above, these functions can be specified by the operation setting information 160 corresponding to the first device 101. In the first application example, all of the functions of the projector 1 explained above are enabled in the first mode.

In the first application example, an outsider can operate the projector 1 while the user using the first device 101 is not using the projector 1. For example, the outsider can operate the operation panel 43 or the remote controller 45 to cause the projector 1 to display an image or couple the external device 100 to the interface section 50. In this case, the external device 100 may be used as the image supply device or control data may be transmitted from the external device 100 to the projector 1 to operate the projector 1.

In the first application example, when the first device 101 is coupled to the projector 1, the projector 1 executes the second mode and only the user using the first device 101 is capable of operating the projector 1.

For example, when the projector 1 is set in a place of education and used and the first device 101 is configured to be used by a teacher, operation by other teachers and students is disabled when the teacher uses the projector 1. Accordingly, it is possible to prevent a situation in which operation performed by the other teachers in other places affects the projector 1 or operation unintended by the teacher is performed. In a state in which the teacher is not using the projector 1, many people can freely use the projector 1.

### 5. Second Application Example

In a second application example, in the first mode, reception of operation by the operation panel 43 and the remote controller 45 is disabled. In the first mode, coupling of the external devices 100 other than the specific external device 100 coupled to the interface section 50 is disabled. For example, coupling of the first interface 51 and the first device 101 is enabled and coupling of the devices other than the first device 101 is disabled. As explained above, these functions can be specified by the first mode information 151. In the second application example, all the functions of the projector 1 explained above are enabled in the second mode.

In the second application example, in a state in which the first device 101 is not coupled to the projector 1, the external device 100 cannot be coupled to the projector 1 and operation by the operation panel 43 and the remote controller 45 cannot be performed. When the user couples the first device 101 to the projector 1, the projector 1 executes the second mode, whereby the operation by the operation panel 43 and the remote controller 45 and the coupling of the external devices 100 other than the first device 101 can be performed.

For example, when the projector 1 set in a public facility is operated according to the second application example, the projector 1 cannot be used while the first device 101 is not used. Therefore, use of the projector 1 other than the purpose can be limited. After the first device 101 is coupled, use of the projector 1 can be performed by various methods such as use in which the second device 102 and the third device 103 are coupled. For example, a plurality of users can respectively operate the first device 101 and the operation panel 43 and cause the projector 1 to display an image.

### 6. Action Effects of the Embodiment

As explained above, the projector 1 applied with the present disclosure includes the projecting section 20, the receiving section 113 that receives operation by a permitted operation unit, and the mode control section 115 that switches the first mode and the second mode in which the operation unit, the operation by which is permitted, is different. The projector 1 includes the interface section 50 coupled to the external device 100 and the identifying section 114 that identifies the external device 100 to which the interface section 50 is coupled. The mode control section 115 executes the first mode when the interface section 50 is not coupled to the specific external device 100 set in advance and executes the second mode when the interface section 50 is coupled to the specific external device 100.

In the control method executed by the projector 1, the first mode and the second mode in which the operation unit, the operation by which is permitted, is different are switched and executed. The external device 100 to which the interface section 50 is coupled is identified. The first mode is executed when the interface section 50 is not coupled to the specific external device 100 set in advance and the second mode is executed when the interface section 50 is coupled to the specific external device 100.

With the projector 1 and the control method for the projector 1, the first mode and the second mode in which the operation unit, the operation by which is permitted, is different are switched according to whether the external device 100 is coupled to the interface section 50. Accordingly, the operation unit, the operation by which is permitted, can be switched according to a coupling state of the external device 100 and the projector 1. Therefore, for example, it is possible to easily change limitation of the functions of the projector 1.

For example, in the first application example explained above, when executing the first mode, the mode control section 115 does not limit the external device 100 to which the interface section 50 is coupled. When executing the second mode, the mode control section 115 limits, to only the external device 100 permitted in advance, the external device 100 to which the interface section 50 is coupled. In this case, it is possible to easily switch a state in which the external device 100 can be freely coupled to the projector 1 and a state in which the coupling of the external device 100 is limited.

In the second application example explained above, when executing the first mode, the mode control section 115 limits, to only the external device 100 permitted in advance, the external device 100 to which the interface section 50 is coupled. When executing the second mode, the mode control section 115 permits operation by an operation means set in advance. In this case, it is possible to easily switch a state in which coupling of the external device 100 to the projector 1 is limited and a state in which the projector 1 can be operated by various means.

When executing the second mode, the control section 10 is capable of changing the limitation of the external device 100 to which the interface section 50 is coupled. For example, as shown in step S20 and step S25 in FIG. 5, the control section 10 is capable of generating and editing the operation setting information 160. Consequently, it is possible to prevent a change, deletion, and the like of the operation setting information 160 not intended by the user.

The interface section 50 includes the first interface 51, the second interface 52, and the third interface 53 as the plurality of interfaces. When executing the second mode, the mode control section 115 limits interfaces coupled to the external device 100 in the interface section 50. Consequently, in the projector 1 including the plurality of interfaces, it is possible to limit coupling of the external device 100 to the interface section 50 and easily switch a limitation state.

When the external device 100 to which the interface section 50 is coupled is permitted as the operation unit, the receiving section 113 receives, as operation on the projector 1, control data transmitted by the external device 100. With this configuration, by limiting coupling of the external device 100, it is possible to limit means for operating the projector 1. Therefore, it is possible to easily switch a limitation state concerning the operation of the projector 1 by switching the first mode and the second mode according to a coupling state of the external device 100.

The projector 1 includes the operation panel 43 and/or the remote controller 45 as the operation section including the operators. When the operation section is permitted as the operation unit, the receiving section 113 receives operation by the operation section. Consequently, it is possible to easily switch a limitation state of the operation by the operation section by switching the first mode and the second mode according to a coupling state of the external device 100.

### 7. Other Embodiments

The embodiment explained above shows a specific example applied with the present disclosure. The present disclosure is not limited to the embodiment.

For example, in the embodiment, the external device 100 coupled to the operation panel 43, the remote controller 45, and the interface section 50 is explained as being equivalent to the means functioning as the operation unit, the operation by which is permitted, in the present disclosure. The present disclosure is not limited to this. A part of the external device 100 may not function as the operation unit. Another device may function as the operation unit.

For example, in the embodiment, the configuration is illustrated in which the projector 1 transitions from the first mode to the second mode when the external device 100 is coupled to the interface section 50. The present disclosure is not limited to this. The projector 1 may be configured to transition from the first mode to the second mode on condition that, for example, the image supply device is coupled to the image interface section 41. The projector 1 may be configured to transition from the first mode to the second mode when a memory device or an HID is coupled to a USB interface included in the interface section 50. That is, the projector 1 may be configured to transition from the first mode to the second mode on condition that a device not having a control function such as the first device 101, the second device 102, or the third device 103 is coupled. In this case, the device information 161 only has to include a device name and device identification information of the device not having a control function.

In the operation shown in FIG. 5, the control section 10 is explained as being configured to be capable of executing the device deletion processing with the setting section 116. However, for example, the control section 10 may include a function of editing the second mode setting information 162 according to operation by the user. The setting section 116 may be configured to be capable of editing the first mode information 151 during the execution of the first mode or the second mode.

For example, in the embodiment, the projector 1 is explained as an example of the display device. However, the display device applied with the present disclosure is not limited to the projector 1. For example, the display device may be a liquid crystal display that displays an image on a liquid crystal panel. The display device may be a display device that displays an image on a plasma display panel or an organic EL (Electro Luminescence) panel. In this case, the liquid crystal panel, the plasma display panel, or the organic EL panel corresponds to an example of the display section.

Further the program to be executed by the processor 11 that performs the operation explained above may be stored in, for example, the storing section 15 or may be stored in another storage device, another storage medium, or a storage medium of an external device and read out and executed by the processor 11.

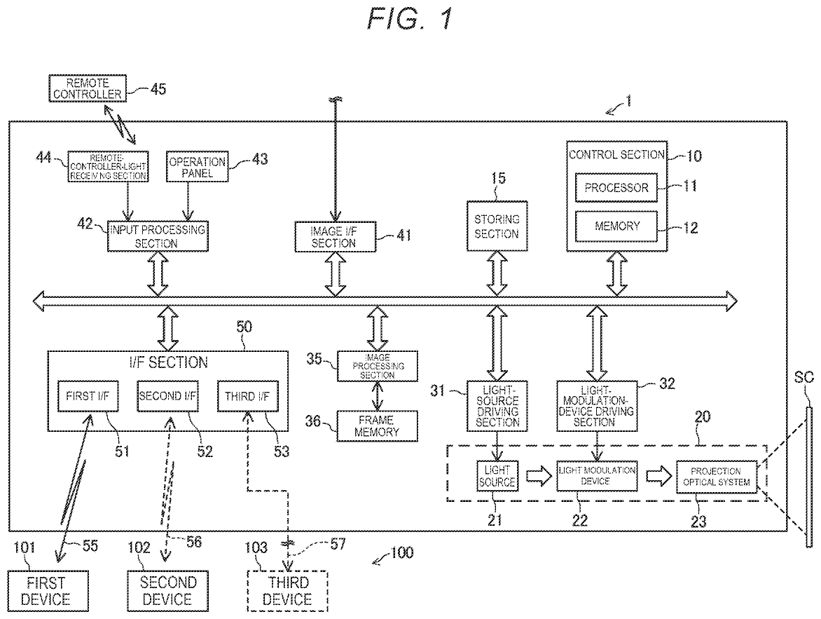

The functional sections shown in FIGS. 1 and 2 show functional components and specific implementation forms of the functional sections are not particularly limited. For example, hardware individually corresponding to the functional sections does not always need to be implemented. It is also naturally possible to adopt a configuration in which one processor executes a program to realize functions of a plurality of functional sections. A part of the functions realized by software in the embodiment may be realized by hardware or a part of the functions realized by hardware may be realized by software. Besides, the specific detailed configurations of the other sections of the projector 1 can be optionally changed in a range not departing from the gist of the present disclosure.

What is claimed is:

1. A display device comprising:
a display section;
a receiving section configured to receive operation by a permitted operation unit;
a mode control section configured to switch a first mode and a second mode in which the operation unit, the operation by which is permitted, is different;
a coupling section configured to be coupled to external devices; and
an identifying section configured to identify one of the external devices to which the coupling section is coupled, wherein
the mode control section executes the first mode when the coupling section is not coupled to a specific one of the external devices set in advance and executes the second mode when the coupling section is coupled to the specific external device.

2. The display device according to claim 1, wherein
when executing the first mode, the mode control section does not limit one of the external devices to which the coupling section is coupled, and
when executing the second mode, the mode control section limits, to only one of the external devices permitted in advance, the external device to which the coupling section is coupled.

3. The display device according to claim 1, wherein
when executing the first mode, the mode control section limits, to only one of the external devices permitted in advance, one of the external devices to which the coupling section is coupled, and
when executing the second mode, the mode control section permits operation of the operation unit set in advance.

4. The display device according to claim 3, wherein, when executing the second mode, the mode control section is capable of changing limitation of the external device to which the coupling section is coupled.

5. The display device according to claim 3, wherein
the coupling section includes a plurality of interfaces, and
when executing the second mode, the mode control section limits one of the interfaces coupled to the external device in the coupling section.

6. The display device according to claim 1, wherein, when the external device to which the coupling section is coupled is permitted as the operation unit, the receiving section receives, as operation on the display device, control information transmitted from the external device.

7. The display device according to claim 6, further comprising an operation section including an operator, wherein
when the operation section is permitted as the operation unit, the receiving section receives operation by the operation section.

8. A control method for a display device including: a display section; a receiving section configured to receive operation by a permitted operation unit; and a coupling section configured to be coupled to external devices, the control method comprising:
switching and executing a first mode and a second mode in which the operation unit, the operation by which is permitted, is different;
identifying one of the external devices to which the coupling section is coupled; and
executing the first mode when the coupling section is not coupled to a specific one of the external devices set in advance and executing the second mode when the coupling section is coupled to the specific external device.
